(19) United States
(12) Patent Application Publication
(10) Pub. No.: US 2025/0198938 A1
(43) Pub. Date: Jun. 19, 2025

(54) AIR BUBBLE DETECTOR

(71) Applicant: CreateLimit Co.,Ltd., Taichung (TW)

(72) Inventor: TSUNG PEI CHAN, Taichung (TW)

(21) Appl. No.: 18/434,644

(22) Filed: Feb. 6, 2024

(30) Foreign Application Priority Data
Dec. 15, 2023 (TW) 112213725

(51) Int. Cl. G01N 21/85; G01N 21/01

(52) U.S. Cl. CPC G01N 21/85; G01N 21/01; G01N 2021/0112; G01N 2201/022

(57) ABSTRACT

An air bubble detector including a case and an optical detection module, the case has a first side, a second side and a tunnel with a first opening at the first side and a second opening at the second side. The optical detection module is provided in the case and communicated with the tunnel. A hose is received in the tunnel of the case via the first opening, and the optical detection module senses optical signals of fluid in the hose for determination of air bubbles in the fluid.

### BACKGROUND OF THE DISCLOSURE

### 1. Field of the Disclosure

The present invention relates generally to manufacture of semiconductor, and more particularly to an air bubble detector for detecting air bubbles in photoresist.

### 2. Description of the Prior Art

Air bubble detectors usually are applied in medical treatment to detect air bubbles in a pipe or hose. A conventional air bubble detector has a case with a slot on a top. An ultrasound transmitter and a receiver are disposed on opposite walls of the slot. A hose is received in the slot to determine air bubbles in the hose by the change of the ultrasound received by the receiver.

In manufacture of semiconductor, photoresist is coated on a copper clad laminate to form a predetermined conductor pattern by photolithography and etching. It is necessary to make sure of no air bubble in the photoresist. However, the conventional air bubble detector, which detects air bubbles via ultrasound, is insufficient to detect sir bubble sin photoresist since the sizes of the air bubble are too small.

### SUMMARY OF THE DISCLOSURE

In light of the above reasons, the primary objective of the present invention is to provide an air bubble detector, which provide a high precision in detection of air bubbles in fluid of a hose.

In order to achieve the primary objective as described above, the present invention provides an air bubble detector including a case and an optical detection module. the case has a first side, a second side and a tunnel with a first opening at the first side and a second opening at the second side. The optical detection module is provided in the case and communicated with the tunnel. A hose is received in the tunnel of the case via the first opening, and the optical detection module senses optical signals of fluid in the hose for determination of air bubbles in the fluid.

In an embodiment, the case has a main case and a holding device; the tunnel and the optical detection module are provided in the main case; the holding device is connected to the main case to be moved toward or away from the main case; the holding device has a holding member to be inserted into the first opening and press against the hose when the holding device is moved toward the main case.

In an embodiment, the holding device has another holding member to be inserted into the second opening and press against the hose when the holding device is moved toward the main case.

In an embodiment, the optical detection module has a first substrate and a photosensor; the first substrate is received in the case, and the photosensor is provided on the first substrate to sense the optical signals of the hose in the tunnel.

In an embodiment, the photosensor has three sensors, two of which are arranged side by side, and the third of which is arranged in an axial direction of the tunnel.

In an embodiment, the optical detection module has a first substrate and two photosensors; the first substrate is received in the case, and the photosensors are provided on the first substrate and kept a predetermined distance in an axial direction of the tunnel to sense illuminance of the hose in the tunnel.

In an embodiment, the first substrate has a bore between the photosensors; the optical detection module further has a second substrate received in the case and distal to the tunnel than the first substrate and a charge-coupled device connected to the second substrate, which has a lens aligned with the bore of the first substrate, to capture optical images of the hose in the tunnel.

In an embodiment, the optical detection module has the charge-coupled device received in the case to capture optical images of the hose in the tunnel.

### BRIEF DESCRIPTION OF THE DRAWINGS

The present invention will be best understood by referring to the following detailed description of one illustrative embodiment in conjunction with the accompanying drawings, in which

FIG. 1 is a perspective view of a preferred embodiment of the present invention;

FIG. 2 is an exploded view of the preferred embodiment of the present invention; and

FIG. 3 is a sectional view of the preferred embodiment of the present invention.

### DETAILED DESCRIPTION

To provide a better understanding for people in this field, the following describes several embodiments of the present invention, along with detailed explanations of the structure and intended benefits of the invention, in conjunction with accompanying drawings. It should be noted that the drawings are simplified schematic representations and, therefore, only show components and their relationships relevant to the invention to provide a clearer description of the basic structure or implementation method of the invention. The actual components and layout may be more complex. Additionally, for the sake of clarity, the components shown in the drawings of the present invention are not drawn with their actual names, compositions, or quantities, and specific names, compositions, and quantities of components can be adjusted according to practical requirements.

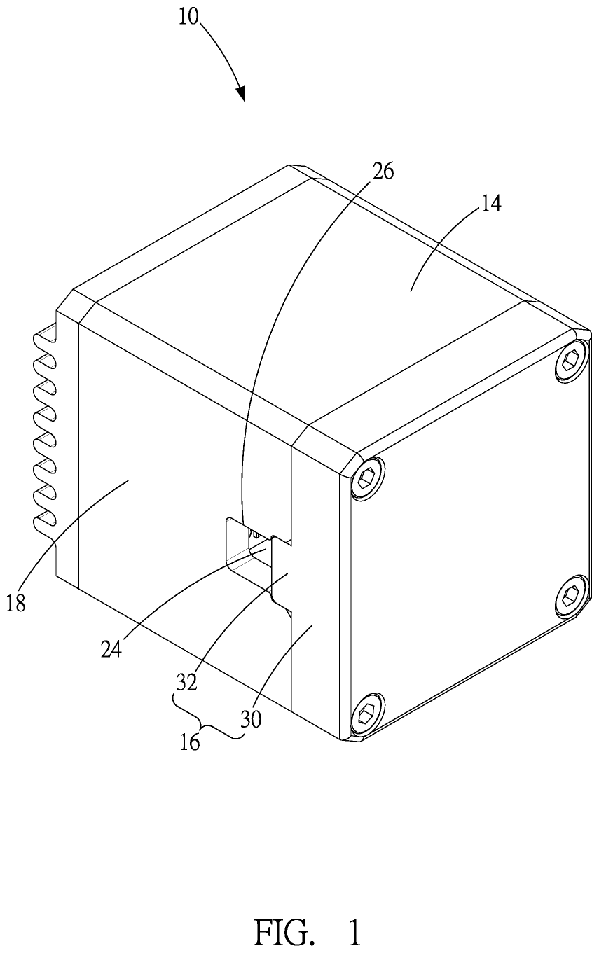

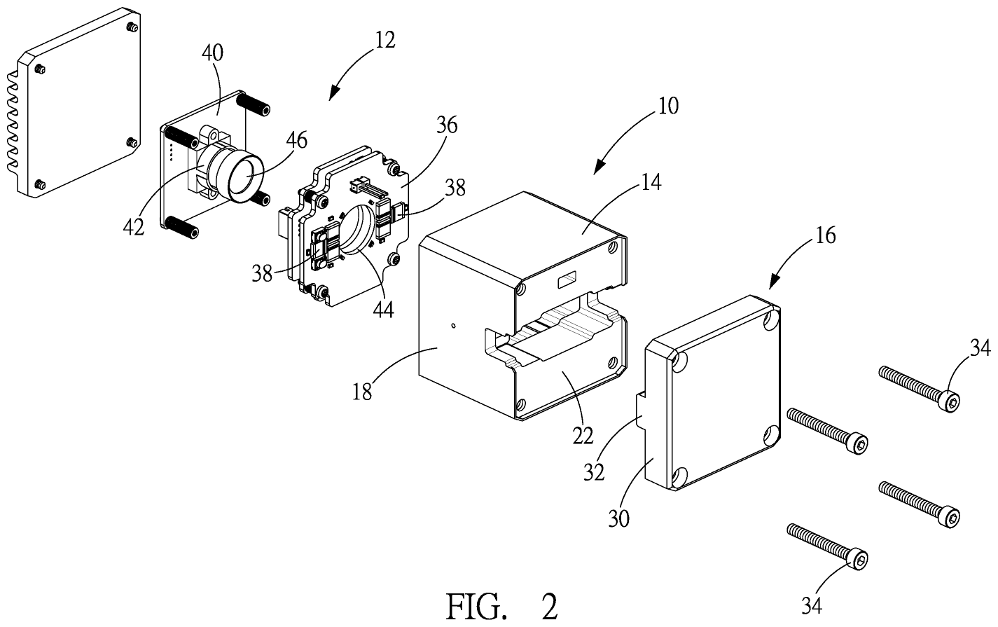

Please refer to FIGS. 1 to 3, an air bubble detector of the preferred embodiment of the present invention includes a case 10 and an optical detection module 12.

The case 10 has a main case 14 and a holding device 16. The main case has a first side 18, a second side 20, which is opposite to the first side 18, and a third side 22 between the first and the second sides 18, 20, and the third side 22 is an open side. The main case 14 is provided with a tunnel 24 with a first opening 26 at the first side 18 and a second opening 28 at the second side 20. The first and the second openings 26, 28 are communicated with the third side 22. The holding device 16 has a main member 30 and two holding members 32. In the present embodiment, the main member 30 is a plate and the holding members 32 are two blocks projected from the main member 30. The main member 30 is connected to the third side 24 of the main case 14, and is able to be moved relative to the main case 14. The holding members 32 are inserted into the first and the second openings 26, 28 to change sizes of the first and the second openings 26, 28 when the main member 30 is moved. In the present embodiment, screws 34 are provided to connect the main member 30 to the main case 14, and the main member 30 is moved by turning the screws 34.

The optical detection module 12 is received in the main case 14 associated with the tunnel 24. In the present embodiment, the optical detection module 12 has a first substrate 36, two photosensors 38, a second substrate 40 and a charge-coupled device (CCD) 42. The first substrate 36 is fixed in the main case 14, and has a bore 44. The photosensors 38 provided on the first substrate 36 at opposite sides of the bore 44, whereby the photosensors 38 are kept a predetermined distance therebetween in an axial direction of the tunnel 24. The photosensors 38 are received in the tunnel 24, and are proximal to the first and the second openings 26, 28 respectively. The CCD 42 is provided on the second substrate 40, which has a lens aligned with the bore 44 of the first substrate 36.

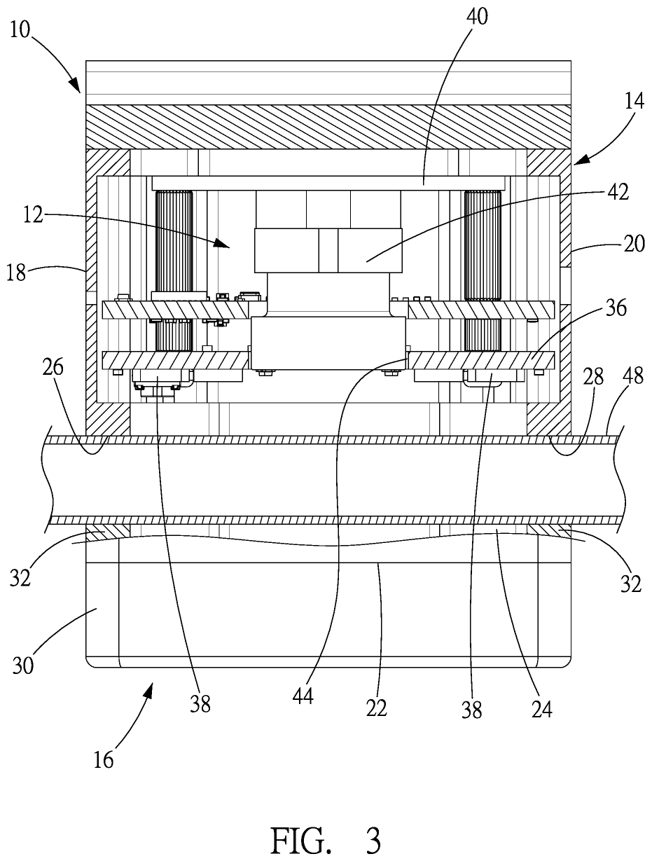

As shown in FIG. 3, a hose 48 is inserted in the tunnel 24 via the first opening 26, and out of the tunnel 24 via the second opening 28. The hose 48 is designated to flow photoresistor in the present embodiment. Next, connect the holding device 16 to the main case 14 to slightly press the holding members 32 against the hose 48 by turning the screws 34. As a result, the hose 48 is firmly held in the tunnel 24 of the case 10. Start the optical detection module 12 to detect optical signals of the hose 48 in the tunnel 24, and the optical signals are transmitted (through wire or wireless) to a computer to determine air bubble in the photoresist.

In the present embodiment, the photosensors 38 detect illuminance to determine air bubble in the photoresist by the change and the distribution of illuminance in the hose 48. The CCD 42 captures optical images of the hose 48 in the tunnel 24 to determine air bubble by image recognition. Still, the photosensors 38 may fail to detect very small air bubbles, and the CCD 42 may help to doublecheck the detection result of the photosensors 38. The detection results of the CCD 42 may be saved as pictures to be searched by users, and the detection results of the photosensors 38 may be used to produce diagrams. A velocity of the photoresist in the hose 48 may be obtained as well because the photosensors 38 are kept the distance therebetween.

In the present embodiment, each photosensor 38 has three sensors, wherein two of the sensors are arranged side by side, and the third one is arranged in the axial direction of the tunnel 24, which is helpful to the detection of the entire hose 48 (especially to the portion adjacent to the wall of the hose 28). If the computer determines an air bubble by the signals of the photosensors 38, the computer may find the size and location of the air bubble, and then the computer continually analyzes the optical image obtained by the CCD 42 and processes an image enhancement at the specified portion where the air bubble is found by the photosensors 38 to obtain precise detection of the air bubble.

Some supplements are described hereunder:
1. The embodiment describes how the optical detection module 12 detects air bubbles in photoresist, however, the present invention may detect air bubble in any fluid. The present invention may be applied in any industry other than semiconductor industry, such as medical industry, mechanical industry, chemical industry etc.
2. The optical detection module 12 of the embodiment is designed to detect optical signals. Any optical sensor, other than photosensor and CCD, such as complementary metal-oxide-semiconductor (CMOS), bolometer, and photographic plate, may be used to be the optical detection module 12.
3. The optical signals obtained by the optical detection module 12 are transmitted to the computer to determine air bubble. The transmission of the optical signals and the determination of air bubble are not the main scope of the present invention. You may find the details in various documents, so I do not describe the detail here.

It should be realized that the above description is only some preferred embodiments of the present invention and should not be deemed as limitations of implementing the present invention. All substantially equivalent variations and modifications which employ the concepts disclosed in this specification and the appended claims should fall within the scope of the present invention.

What is claimed is:

1. An air bubble detector, comprising:
a case having a first side, a second side and a tunnel with a first opening at the first side and a second opening at the second side; and
an optical detection module provided in the case and communicated with the tunnel;
wherein a hose is received in the tunnel of the case via the first opening, and the optical detection module senses optical signals of fluid in the hose for determination of air bubbles in the fluid.

2. The air bubble detector of claim 1, wherein the case has a main case and a holding device; the tunnel and the optical detection module are provided in the main case; the holding device is connected to the main case to be moved toward or away from the main case; the holding device has a holding member to be inserted into the first opening and press against the hose when the holding device is moved toward the main case.

3. The air bubble detector of claim 2, wherein the holding device has another holding member to be inserted into the second opening and press against the hose when the holding device is moved toward the main case.

4. The air bubble detector of claim 1, wherein the optical detection module has a first substrate and a photosensor; the first substrate is received in the case, and the photosensor is provided on the first substrate to sense the optical signals of the hose in the tunnel.

5. The air bubble detector of claim 4, wherein the photosensor has three sensors, two of which are arranged side by side, and the third of which is arranged in an axial direction of the tunnel.

6. The air bubble detector of claim 1, wherein the optical detection module has a first substrate and two photosensors; the first substrate is received in the case, and the photosensors are provided on the first substrate and kept a predetermined distance in an axial direction of the tunnel to sense illuminance of the hose in the tunnel.

7. The air bubble detector of claim 6, wherein the first substrate has a bore between the photosensors; the optical detection module further has a second substrate received in the case and distal to the tunnel than the first substrate and a charge-coupled device connected to the second substrate, which has a lens aligned with the bore of the first substrate, to capture optical images of the hose in the tunnel.

8. The air bubble detector of claim 1, wherein the optical detection module has the charge-coupled device received in the case to capture optical images of the hose in the tunnel.
